(19) United States
(12) Patent Application Publication
(10) Pub. No.: US 2007/0241723 A1
(43) Pub. Date: Oct. 18, 2007

(54) Device for Monitoring a Motor Vehicle Alternator Based on the Life Situation of Said Vehicle, and Associated Method

(75) Inventor: Delphine Billat, Triel sur Seine (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/576,148

(22) PCT Filed: Sep. 20, 2005
(86) PCT No.: PCT/FR05/50768

§ 371 Date: Mar. 27, 2007

(30) Foreign Application Priority Data
Oct. 8, 2004 (FR) 0410649

(51) Int. Cl. H02H 7/06

(52) U.S. Cl. 322/28

(57) ABSTRACT

The invention concerns a device for monitoring a motor vehicle alternator capable of determining the regulating voltage (Vreg) of said alternator based on the vehicle life situation, said device comprising means (10) for acquiring a plurality of variables (P %, Vel, Acc, I, R, C, O/S) representing the current situation of the vehicle, assessing means (20) for determining whether the vehicle is in a plurality of predetermined life situations, and regulating means (30) for determining the alternator regulating voltage (Vreg) based on the predetermined life situation in which the vehicle is.

The invention concerns generally motor vehicle alternators, and the devices for driving these alternators.

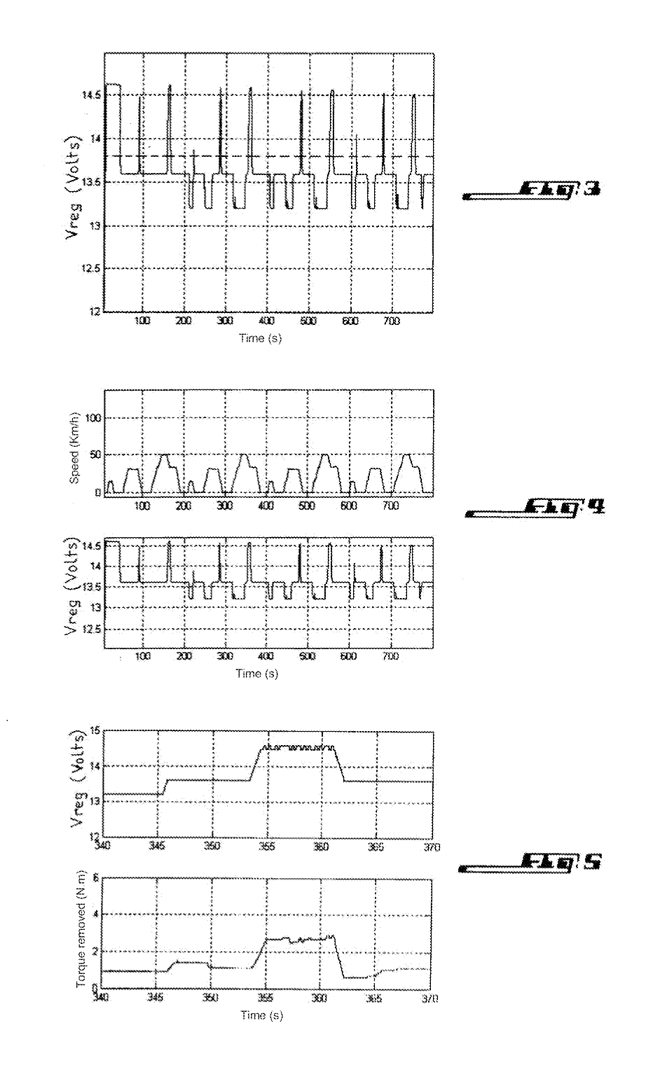

Alternators driven in accordance with the prior art rotate permanently at a speed which is a function of the engine speed, and they supply the electrical consumers of the vehicle via the battery. The regulation voltage at the terminals of the alternator is substantially constant (see the curve in interrupted line on FIG. 3), this voltage varying slightly as a function of the active electrical consumers. To supply electrical power, the alternator removes permanently a torque from the heat engine, this torque corresponding to a portion of the fuel consumption of the vehicle.

With the rapid increase in the number of electrical consumers on-board the vehicle, the alternator is more and more solicited. The torque removed from the heat engine increases, which is very penalizing for the fuel consumption.

In this context, a goal of the present invention is to remedy the above-mentioned drawbacks.

This objective is reached with the help of a device for driving a motor vehicle alternator adapted to determine the regulation voltage of said alternator as a function of the life situation of the vehicle, this device comprising means for acquiring a plurality of variables representative of the current situation of the vehicle, evaluating means to determine, as a function of the acquired variables, whether the vehicle finds itself in one of a plurality of predetermined life situations, and regulating means to determine the regulation voltage of the alternator as a function of the predetermined life situation in which the vehicle finds itself.

The driving device can also have one or several of the following characteristics.
The predetermined life situations can comprise at least the situation of an acceleration of the vehicle, the situation of a deceleration of the vehicle, and the situation of a stabilized speed of the vehicle.
The regulating means can comprise a regulation manager determining a set point voltage in a first, relatively lower predetermined range when the vehicle is the situation of an acceleration, in a second, relatively higher predetermined range when the vehicle is the situation of a deceleration, and in a third, intermediary predetermined range between the high and low ranges when the vehicle is in the situation of a stabilized speed, the regulation voltage being a function of the set point voltage.
The device can comprise means for acquiring the current temperature of the battery of the vehicle, and protecting means to evaluate a maximal acceptable regulation voltage of the alternator as a function of the acquired temperature, the regulation voltage being a function of the minimum among the set point voltage and the maximal voltage.
The driving device can further comprise means for acquiring the current voltage at the terminals of the battery of the vehicle, and assessing means to evaluate the current state of charge of the battery as a function of the acquired battery voltage, of the acquired temperature of the battery, and of the regulation voltages previously applied to the alternator, the regulation manager determining the set point voltage in a fourth predetermined range when the state of charge of the battery is lower than a predetermined threshold.
The regulation manager can determine the set point voltage in the fourth predetermined range also when the voltage of the battery is lower than a predetermined threshold.
The device can comprise means for detecting whether a consumer sensitive to the variations of the voltage of the battery is active, the regulating means then determining directly a sensitive consumer voltage in a fifth predetermined range, without implicating the regulation manager, the regulation voltage being determined as a function of said sensitive consumer voltage.
The regulating means can comprise filtering means receiving as input, on the one hand, the minimum voltage among the set point voltage and the maximal voltage, and on the other hand, the sensitive consumer voltage, and determining the regulation voltage as a function of the inputs so as to maintain the variations with time of said regulation tension below a predetermined slope.
The predetermined life situations can also comprise the situation of operation start-up of the engine, the regulation manager determining the set point voltage in a sixth predetermined range when the vehicle is in a situation of operation start-up of the engine.
The variables representative of the current situation of the vehicle can be selected among the variables available in a computer of the motor vehicle, and can comprise, for example, the position of the acceleration pedal, the speed of the vehicle, the acceleration of the vehicle, the state of the injection, the state of the regulation of the idle, the state of the heat engine-gear box coupling, and the state of the heat engine.

According to a second aspect, the invention is directed to a method for driving a motor vehicle alternator consisting in determining the regulation tension of said alternator as a function of the life situation of the vehicle, this method comprising the following steps:

1/ acquisition of a plurality of variables representative of the current situation of the vehicle,

2/ evaluation, as a function of the acquired variables, whether the vehicle finds itself in one of a plurality of predetermined life situation,

3/ determination of the regulation voltage of the alternator as a function of the predetermined life situation in which the vehicle finds itself.

Other characteristics and advantages of the invention will clearly appear from the following description thereof, made by way of a non-limitative illustration only, in reference to the annexed Figures, in which:

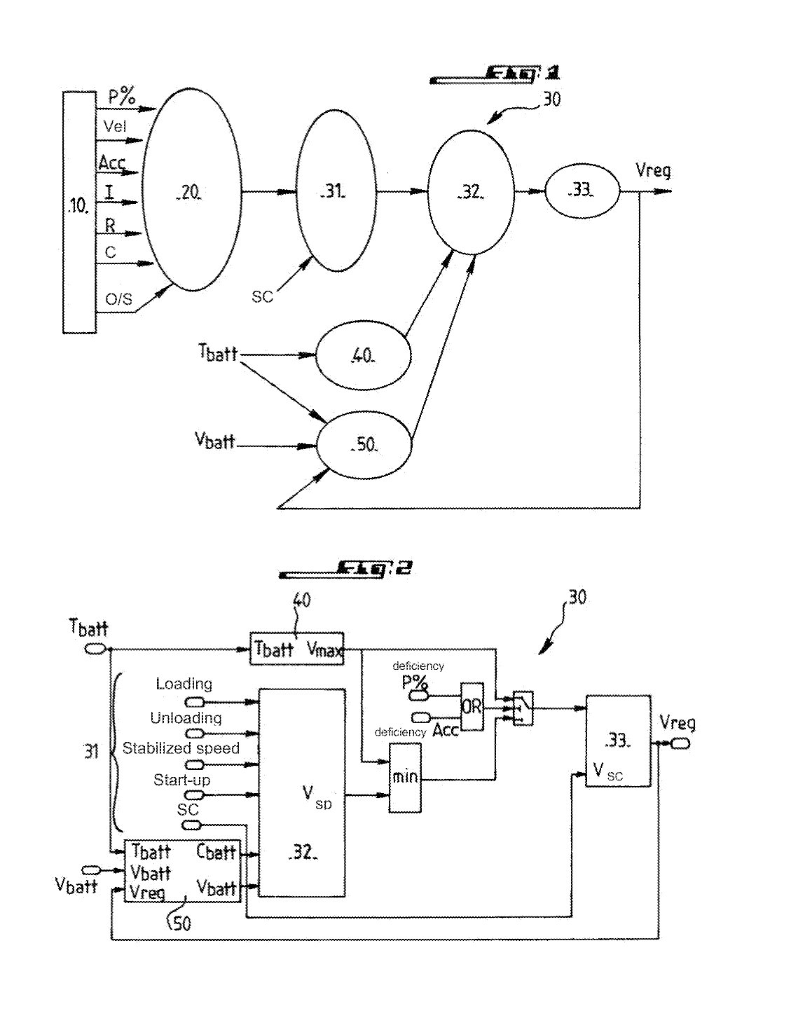

FIG. 1 is a schematic view of the various functional sub-assemblies of the device according to the invention,

FIG. 2 is a detailed view of some sub-assemblies of FIG. 1,

FIG. 3 is a view in graphic form of the regulation voltage applied to the alternator (ordinates in volts) as a function of time (abscissa, in seconds), in the state of the art (interrupted line) and according to the invention (uninterrupted line),

FIG. 4 is a view in graphic form of the speed of the vehicle (top graph, in km/h) and of the regulation voltage applied to the alternator according to the invention (bottom graph, in volts) as a function of time (in abscissa, in seconds), and

FIG. 5 is a view in graphic form of the regulation voltage applied to the alternator according to the invention (top graph, in volts) and of the torque removed from the heat engine (bottom graph, in N.m) as a function of time (abscissa, in seconds), for only a portion of the time interval under consideration in FIGS. 3 and 4.

A function of the device shown schematically on FIGS. 1 and 2 is to drive a motor vehicle alternator, not shown, by determining the regulation voltage Vreg of said alternator and by imposing this voltage at its terminals.

The regulation voltage Vreg is determined as a function of the life situation of the vehicle, so as to modulate the torque removed from the engine as a function of the circumstances.

The higher the regulation voltage Vreg, the more torque is removed by the alternator from the engine, and the higher is the fuel consumption. When this voltage is equal to the open circuit voltage of the battery, the alternator almost stops removing torque from the engine, which reduces the fuel consumption.

It is visible on FIG. 1 that the driving device comprises means 10 for acquiring a plurality of variables representative of the current situation of the vehicle, evaluating means 20 to determine, as a function of the acquired variables, whether the vehicle finds itself in one of a plurality of predetermined life situations, and regulating means 30 to determine the regulation voltage Vreg of the alternator as a function of the predetermined life situation in which the vehicle finds itself.

The variables representative of the current situation of the vehicle are selected among the variables available in a computer of the motor vehicle, typically in the engine monitoring computer.

These variables comprise preferably the position of the acceleration pedal P %, the speed of the vehicle Vel, the acceleration of the vehicle Acc, the state of the injection I, the state of the regulation of the idle R, the state of the heat engine-gear box coupling C, and the state of the heat engine O/S.

The position of the acceleration pedal translates the desire of the driver and is expressed in percentages of the maximal course of the pedal, 0% representing a pedal that is not pushed down at all and 100% a pedal that is completely pushed down.

The state of the injection I is a variable that can adopt two states: injection inactive (no fuel injected into the cylinders of the heat engine), or injection active.

The state of the regulation of the idle R is a variable that can adopt two states: regulation active (heat engine being in idle), or regulation inactive.

The state of the heat engine-gear box coupling C is a variable that can adopt two states: engine and gear box coupled (the torque of the engine is transmitted to the gear box and to the wheels, clutch in the engaged state), or uncoupled (torque not transmitted, clutch in disengaged state).

The state of the heat engine O/S is a variable that can adopt two states: engine in operation or engine stopped (no combustion).

The predetermined life situations comprise at least the situation of an acceleration of the vehicle, the situation of a deceleration of the vehicle, and the situation of a stabilized speed of the vehicle. They usually also comprise the situation of operation start-up of the vehicle.

The acceleration situation corresponds to a phase during which the speed of the vehicle increases.

The deceleration situation corresponds to a phase during which the speed of the vehicle decreases.

The stabilized speed situation corresponds to a phase during which the speed of the vehicle does not change or changes within a narrow range.

The engine operation start-up situation corresponds to the passage from the stopped engine state to the operating engine state, i.e., to start-up of the engine.

Each of these situations is detected by using one or several of the variables acquired by the means 10.

The acceleration situation is detected by using, for example, the position of the acceleration pedal P %, the speed of the vehicle Vel, and the acceleration of the vehicle Acc.

The deceleration situation of the vehicle is detected by using, for example, the state of the injection I (injection inactive), the speed of the vehicle Vel, and the acceleration of the vehicle Acc.

The stabilized speed situation is detected when the vehicle is neither in a deceleration situation nor in an acceleration situation, and by using, for example, the state of the regulation of the idle (regulation active), the speed of the vehicle Vel, and the acceleration of the vehicle Acc.

The operation start-up situation is detected by using, for example, the state of the heat engine-gear box coupling C, and the state of the heat engine O/S.

It is also visible on FIG. 1 that the driving device comprises means for acquiring the current temperature of the battery of the vehicle Tbatt, and protecting means 40 to evaluate a maximal acceptable regulation voltage Vmax of the alternator as a function of the acquired temperature Tbatt.

This maximal voltage Vmax is determined with the help of predetermined tables, mappings, or equations, which are known in themselves.

The driving device comprises means for acquiring the current voltage at the terminals of the battery of the vehicle Vbatt, and assessing means 50 to evaluate the current state of charge of the battery Cbatt as a function of the acquired battery voltage Vbatt, of the acquired temperature of the battery Tbatt, and of the regulation voltages Vreg previously applied to the alternator.

This state of charge Cbatt is determined by assessing the periods of charge and discharge of the battery, with the help of equations known in themselves.

The regulating means 30 comprise activating means 31 activating, as a function of the life situation determined by the evaluating means 20, a state among the loading, unloading, stabilized speed, and start-up states, a regulation manager 32 determining a set point voltage Vsp at least as a function of the state activated by the activating means 31, and filtering means 33 determining the regulation voltage Vreg at least as a function of the set point voltage Vsp.

It is added for precision that the device comprises means for detecting whether a consumer sensitive to the variations of the voltage of the battery SC is active, i.e., supplied with electric current from the battery or from the alternator. This information is transmitted to the activating means 31.

The sensitive consumers are typically the head lights of the vehicle and the ventilation and air conditioning devices of the vehicle. These consumers must be subjected only to very progressive voltage variations, so that the passengers cannot perceive any modification in the light intensity of the head lights or in the ventilation air flow rate.

The loading state is activated by the activating means 31 in the deceleration situation, when no sensitive consumer is active. This state is favorable to remove more torque from the heat engine.

The unloading state is activated by the activating means 31 in the acceleration situation, when no sensitive consumer is active. So as to provide more verve to the vehicle and to make stronger accelerations possible, it is preferable to remove less torque from the heat engine in this state.

The stabilized speed state is activated in the situation of a stabilized speed, when no sensitive consumer is active.

The start-up state is activated in the situation of operation start-up.

The regulation manager 32 is informed of the activated state by the activating means 31, and in addition, it receives from the assessing means 50 the current values of the state of charge of the battery Cbatt and of the battery voltage Tbatt (see FIG. 2).

The regulation manager 32 selects the set point voltage Vsp in a first, relatively lower predetermined range when the unloading state is activated, in a second, relatively higher predetermined range when the loading state is activated, in a third, intermediary predetermined range between the high and low ranges when the stabilized speed state is activated.

The regulation manager 32 determines the set point voltage Vsp in a sixth, low predetermined range, generally close to 12 volts, when the start-up state is activated, i.e., when the alternator operates as a starter, so as to avoid discharging the battery too much.

The set point voltage Vsp is selected in a fourth predetermined range when the state of charge of the battery Cbatt is lower than a predetermined threshold or when the voltage of the battery Tbatt is lower than a predetermined threshold, and this in any of the activated states. In this situation, recharging the battery has priority over optimizing the operation of the alternator and the corresponding fuel savings.

The fourth range is relatively high.

It will be noted that it is possible to envision that the regulating means 32 select the set point voltage Vsp in different ranges when the state of charge of the battery is low, and when the temperature of the battery is low.

It is visible on FIG. 2 that the regulating means 30 compare subsequently the set point voltage Vsp to the maximal voltage Vmax determined by the protecting means 40, the minimum among the set point voltage Vsp and the maximal voltage Vmax being transmitted to the filtering means 33.

In the case of a deficiency of the means for acquiring the position of the acceleration pedal or the vehicle acceleration, what is transmitted to the filtering means, independently from the value of the set point voltage Vsp, is the maximal voltage Vmax.

The filtering means 33 receive as input, either the minimum voltage among the set point voltage Vsp and the maximal voltage Vmax, or the maximal voltage Vmax, and they determine the regulation voltage as a function of the input voltage so as to maintain the variations with time of said regulation voltage Vreg below a first predetermined slope.

Further, in the case where a sensitive consumer SC is active, the regulating means 30 then determine directly a sensitive consumer voltage Vsc in a fifth predetermined range, without implicating the managing means 32, this voltage being sent as input to the filtering means 33.

These filtering means 33 then determine the regulation voltage Vreg as a function of said sensitive consumer voltage Vsc, so as to maintain the variations with time of said regulation voltage Vreg below a second predetermined slope.

The second slope usually is, in absolute value, lower than the first.

It will be noted that it is provided in the driving device a degraded operating mode that is applied during about 200 seconds after the start of operation of the engine (operation starting situation). In this degraded operating mode, only the loading and stabilized speed states are authorized, the unloading state being prohibited.

This degraded mode makes it possible to quickly recharge the battery after the engine has been started, and to start the normal driving of the alternator with a fully charged battery.

The voltage values in the various ranges are selected with the help of tables, mappings, or formulae known in themselves.

All the means described above, except the means for acquiring variables or data, are computing means, arranged in an on-board computer of the vehicle.

FIGS. 3 to 5 illustrate the results obtained with the help of the above-described device.

It is visible on FIG. 3 that the regulation voltage of an alternator driven according to the prior art is substantially constant and equal to about 13.8 volts.

On the contrary, the regulation voltage of an alternator driven by the above-described device varies as a function of time, depending on the life situations of the vehicle.

FIG. 4 shows in parallel the evolution of the speed of the vehicle and the evolution of the regulation voltage Vreg.

It is visible that the device operates in degraded mode until after 200 seconds.

After 200 seconds, the device switches to normal mode and all the states are authorized. At each acceleration, the regulation voltage Vreg decreases, and at each deceleration, the regulation voltage Vreg increases.

FIG. 5 shows that the variations of the regulation voltage Vreg at the terminals of the alternator have a significant effect on the torque removed from the heat engine by the alternator. It is visible that the removed torque increases with the voltage and goes from 1 to 3 N.m when the voltage goes from 13.2 volts to 14.5 volts.

The higher the removed torque, the higher the fuel consumption.

The above-described driving device has multiple advantages.

It makes it possible to regulate the operation of the alternator by the voltage imposed at its terminals, and to adapt the operating point of the alternator as a function of the life situation of the vehicle.

Thus, a lower regulation voltage is imposed in the situations where the vehicle needs a high engine torque, i.e., in the acceleration phases. Thus, the verve of the vehicle and its ability to acceleration are increased, for moving off a stopped state or for a passing maneuver.

The driving pleasure is thus increased, which is a commercial advantage for the vehicle.

A higher regulation voltage is imposed in the situations where the vehicle has no or little need for the engine torque, i.e., in the deceleration phases. A portion of the engine torque can then be removed to recharge the battery without a downside for the operation of the vehicle and without reducing its performance.

This particularly fine management of the alternator makes it possible to maintain the battery constantly charged, while reducing the average fuel consumption.

These performances are obtained in a particularly economical way, since it is not necessary to add sensors on the vehicle. The information required for the detection of the life situations of the vehicle is available in the on-board computers.

Finally, the device comprises various functionalities, making it possible to maintain the battery at an acceptable temperature, to maintain its state of charge at a sufficient level, and to limit the instantaneous variations of the regulation voltage so that the passengers of the vehicle cannot perceive these variations. The regulation voltage varies sufficiently slowly so that, for example, the light intensity of the head lights or the ventilation air flow rate seems constant.

1. Device for driving a motor vehicle alternator adapted to determine the regulation voltage of said alternator as a function of the life situation of the vehicle, this device comprising means for acquiring a plurality of variables representative of the current situation of the vehicle, evaluating means to determine, as a function of the acquired variables, whether the vehicle finds itself in one of a plurality of predetermined life situations, and regulating means to determine the regulation voltage of the alternator as a function of the predetermined life situation in which the vehicle finds itself.

2. Device according to claim 1, wherein the predetermined life situations comprise at least the situation of an acceleration of the vehicle, the situation of a deceleration of the vehicle, and the situation of a stabilized speed of the vehicle.

3. Device according to claim 2, wherein the regulating means comprise a regulation manager determining a set point voltage in a first, relatively lower predetermined range when the vehicle is a situation of an acceleration, in a second, relatively higher predetermined range when the vehicle is the situation of a deceleration, and in a third, intermediary predetermined range between the high and low ranges when the vehicle is in the situation of a stabilized speed, the regulation voltage being a function of the set point voltage.

4. Device according to claim 3, which comprises means for acquiring the current temperature of the battery of the vehicle, and protecting means to evaluate a maximal acceptable regulation voltage of the alternator as a function of the acquired temperature, the regulation voltage being a function of the minimum among the set point voltage and the maximal voltage.

5. Device according to claim 4, which comprises means for acquiring the current voltage at the terminals of the battery of the vehicle, and assessing means to evaluate the current state of charge of the battery as a function of the acquired battery voltage, of the acquired temperature of the battery, and of the regulation voltages previously applied to the alternator, the regulation manager determining the set point voltage in a fourth predetermined range when the state of charge of the battery is lower than a predetermined threshold.

6. Device according to claim 5, wherein the regulation manager determines the set point voltage in the fourth predetermined range also when the voltage of the battery is lower than a predetermined threshold.

7. Device according to claim 5, which comprises means for detecting whether a consumer sensitive to the variations of the voltage of the battery is active, the regulating means then determining directly a sensitive consumer voltages in a fifth predetermined range, without implicating the regulation manager, the regulation voltage being determined as a function of said sensitive consumer voltage.

8. Device according to claim 7, wherein the regulating means comprise filtering means receiving as input, on the one hand, the minimum voltage among the set point voltage and the maximal voltage, and on the other hand, the sensitive consumer voltage, and determining the regulation voltage as a function of the inputs so as to maintain the variations with time of said regulation tension below a predetermined slope.

9. Device according to claim 3, wherein the predetermined life situations also comprise the situation of operation start-up of the engine, the regulation manager determining the set point voltage in a sixth predetermined range when the vehicle is in a situation of operation start-up of the engine.

10. Device according to claim 1, wherein the variables representative of the current situation of the vehicle are selected among the variables available in a computer of the motor vehicle.

11. Method for driving a motor vehicle alternator implementing a determination of the regulation tension of said alternator as a function of the life situation of the vehicle, this method comprising the following steps:
1/ acquiring a plurality of variables representative of the current situation of the vehicle,
2/ evaluating, as a function of the acquired variables, whether the vehicle finds itself in one of a plurality of predetermined life situation,
3/ determining the regulation voltage of the alternator as a function of the predetermined life situation in which the vehicle finds itself.

12. Device according to claim 10, wherein the variables representative of the current situation of the vehicle comprise the position of the acceleration pedal, the speed of the vehicle, the acceleration of the vehicle, the state of the injection, the state of the regulation of the idle, the state of the heat engine-gear box coupling, and the state of the heat engine.
